(19) United States
(12) Patent Application Publication
(10) Pub. No.: US 2026/0329469 A1
(43) Pub. Date: Oct. 22, 2026

(54) COUNTER-BASED PARITY TESTING FOR MEMORY DEVICES

(71) Applicant: Micron Technology, Inc., Boise, ID (US)

(72) Inventors: Woo Hyun PAIK, Suwanee, GA (US); Yong-jae LEE, Suwanee, GA (US)

(21) Appl. No.: 19/468,241

(22) Filed: Feb. 3, 2026

Related U.S. Application Data
(60) Provisional application No. 63/782,805, filed on Apr. 3, 2025.

(51) Int. Cl. G06F 3/06

(52) U.S. Cl. CPC G06F 3/0653; G06F 3/0604; G06F 3/0679

(57) ABSTRACT

Implementations described herein relate to counter-based parity testing for memory devices. In some implementations, a memory device may obtain an error signal that indicates whether an error is associated with a parity logic. The memory device may provide the error signal to a plurality of counters associated with a parity test of the parity logic. The memory device may identify a counter of the plurality of counters based on a presence of the error in the parity logic, wherein a counter increase associated with the counter is blocked based on the presence of the error. The memory device may identify one or more of a flip-flop or a logic gate associated with the parity logic based on the counter, wherein the flip-flop or the logic gate is associated with a source of the error.

### CROSS-REFERENCE TO RELATED APPLICATION

This Patent Application claims priority to U.S. Provisional Patent Application No. 63/782,805, filed on Apr. 3, 2025, entitled “COUNTER-BASED PARITY TESTING FOR MEMORY DEVICES,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to a counter-based parity testing for a memory device.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of counter-based parity testing for memory devices.

FIG. 2 is a diagrammatic view of an example memory device.

FIG. 3 is a diagram illustrating an example of a parity self-test.

FIG. 4 is a diagram illustrating an example of a parity test sequence.

FIG. 5 is a diagram illustrating an example of an error signal.

FIG. 6 is a diagram illustrating an example of a parity test counter.

FIG. 7 is a diagram illustrating an example of a timing diagram associated with a parity test counter.

FIG. 8 is a flowchart of an example method associated with counter-based parity testing.

### DETAILED DESCRIPTION

In high bandwidth memory, a parity self-test may be a diagnostic check performed to verify data integrity using parity bits. The parity self-test may be performed to ensure that no data corruption occurs during storage or transmission. The parity self-test may occur periodically or may be triggered manually (e.g., during bootup or system diagnostics).

In the parity self-test, data may be latched in a plurality of flip-flops. The data may include multiple “0” values and one “1” value. For example, the plurality of flip-flops may include 16 flip-flops. At a first time, an input of 1 may be provided to a first flip-flop, and an input of 0 may be provided to remaining flip-flops. At a second time, an input of 1 may be provided to a second flip-flop, and an input of 0 may be provided to remaining flip-flops. This process may be repeated 16 times corresponding to the 16 flip-flops. This process may be referred to as “walking 1” because an input of 1 may be provided to different flip-flops each time. The data may be subjected to a plurality of XOR operations. A check may be performed as to whether an even number of 1s or an odd number of 1s result from the plurality of XOR operations. Since only one flip-flop may receive an input of 1 (high) and remaining flip-flops may receive an input of 0 (low), an output of “high” may indicate no error. On the other hand, when an output is not “high”, an error (e.g., sticky error) may be issued in parity logic. In other words, when the output is not “high”, the plurality of XOR operations may result in the error. The error may be associated with an issue in the parity logic.

For high bandwidth memory, the parity self-test may be supported to check the plurality of XOR operations. The parity self-test may be a write and read parity test. However, the parity self-test may not indicate which specific XOR operation is associated with an error (failure). For example, an input that is directed to a flip-flop may be associated with multiple XOR operations as part of the parity self-test. The parity self-test may indicate whether or not an error occurred during at least one XOR operation of the plurality of XOR operations, but the parity self-test may not indicate which specific XOR operation is (or which specific multiple XOR operations are) associated with the error. Each XOR operation may potentially be associated with an error, which may result in the output not being “high”. An inability to determine which XOR operation is associated with an error may degrade an effectiveness of the parity self-test, thereby degrading an overall system performance.

In some implementations, a memory device, such as a memory device associated with high bandwidth memory, may obtain an error signal that indicates whether an error is associated with a parity logic. The error signal may be associated with a high value based on a presence of the error. Alternatively, the error signal may be associated with a low value based on an absence of the error. The memory device may provide the error signal to a plurality of counters associated with a parity test of the parity logic. In a specific example, the memory device may provide a clock signal (e.g., a complementary clock signal) to the plurality of counters, where the clock signal may be based on the error signal. A quantity associated with the plurality of counters may be based on a quantity of read or write commands associated with the parity logic. The memory device may identify a counter of the plurality of counters based on the presence of the error in the parity logic. Different counters in the plurality of counters may be associated with different flip-flops of the parity logic, and a specific flip-flop may be associated with one or more logic gates. A counter increase associated with the counter may be blocked based on the presence of the error. On the other hand, the counter increase may not be blocked when the error is absent. The memory device may identify a flip-flop and/or a logic gate (e.g., an XOR logic gate) associated with the parity logic based on the counter, where the flip-flop or the logic gate may be associated with a source of the error. The error signal may block a clock toggle based on the presence of the error, where the counter may be stopped at the flip-flop and/or the logic gate (e.g., a last error-free flip-flop or a last error-free logic gate) prior to the clock toggle being blocked.

In some implementations, by placing the plurality of counters and by blocking the counter increase when the error occurs (e.g., blocking the clock toggle when the error occurs, as indicated by the error signal), a specific counter may stop (e.g., the counter may not be increased), where that counter may correspond to a certain flip-flop and/or logic gate (or multiple logic gates). By placing the plurality of counters and by detecting which specific counter is not increased, the certain flip-flop and/or logic gate that is associated with a parity logic failure may be identified. Otherwise, an error associated with the parity logic may be detected, but the specific flip-flop and/or logic gate associated with the error may be unknown. An ability to detect the specific flip-flop and/or logic gate associated with the error may improve an effectiveness of the parity self-test, thereby improving an overall system performance.

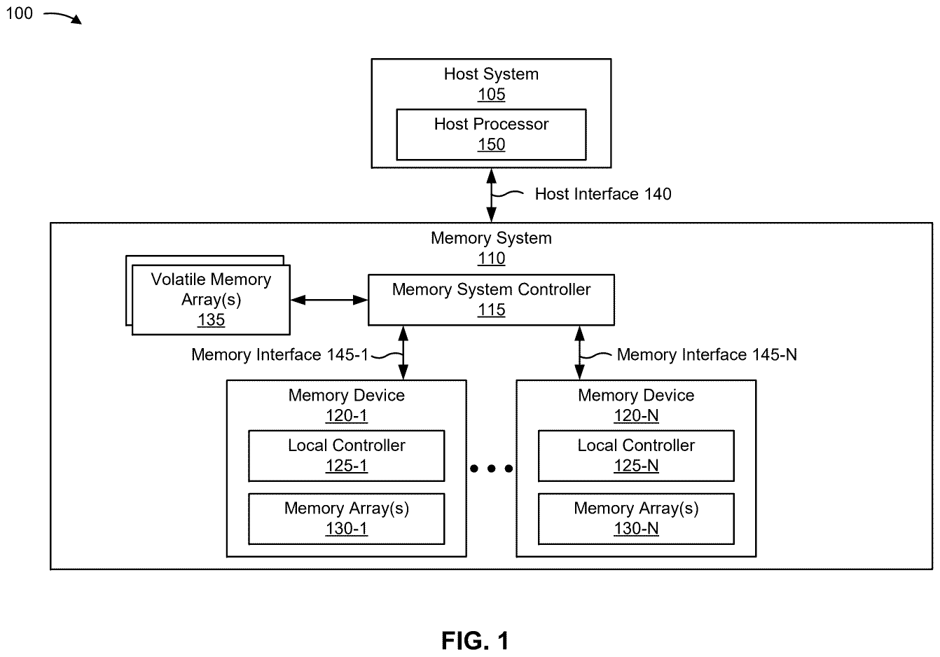

FIG. 1 is a diagram illustrating an example system 100 capable of counter-based parity testing for memory devices. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to obtain an error signal that indicates whether an error is associated with a parity logic; provide the error signal to a plurality of counters associated with a parity test of the parity logic; identify a counter of the plurality of counters based on a presence of the error in the parity logic, wherein a counter increase associated with the counter is blocked based on the presence of the error; and identify one or more of a flip-flop or a logic gate associated with the parity logic based on the counter, wherein the flip-flop or the logic gate is associated with a source of the error.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

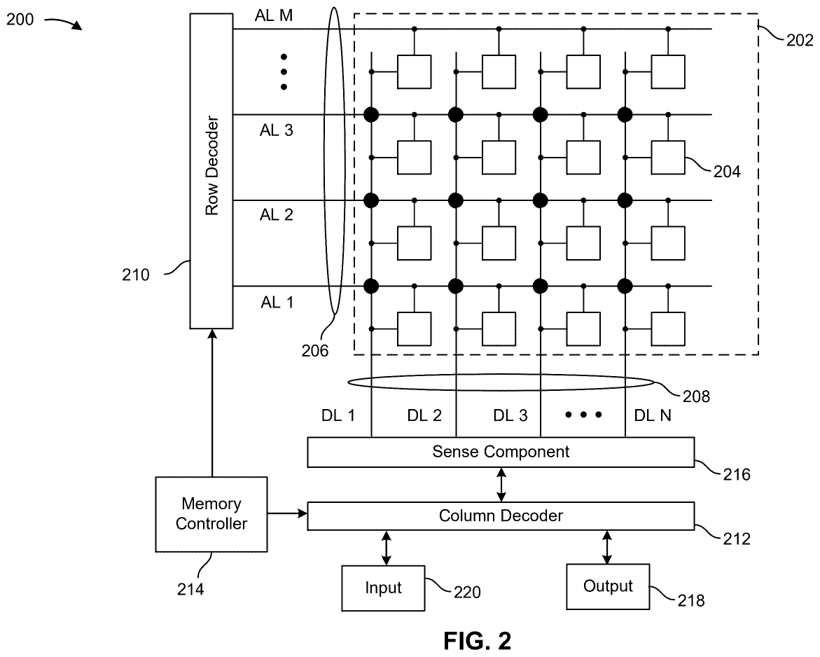

FIG. 2 is a diagrammatic view of an example memory device 200. The memory device 200 may include a memory array 202 that includes multiple memory cells 204. A memory cell 204 is programmable or configurable into a data state of multiple data states (e.g., two or more data states). For example, a memory cell 204 may be set to a particular data state at a particular time, and the memory cell 204 may be set to another data state at another time. A data state may correspond to a value stored by the memory cell 204. The value may be a binary value, such as a binary 0 or a binary 1, or may be a fractional value, such as 0.5, 1.5, or the like. A memory cell 204 may include a capacitor to store a charge representative of the data state. For example, a charged and an uncharged capacitor may represent a first data state and a second data state, respectively. As another example, a first level of charge (e.g., fully charged) may represent a first data state, a second level of charge (e.g., fully discharged) may represent a second data state, a third level of charge (e.g., partially charged) may represent a third data state, and so on.

Operations such as reading and writing (i.e., cycling) may be performed on memory cells 204 by activating or selecting the appropriate access line 206 (shown as access lines AL 1 through AL M) and digit line 208 (shown as digit lines DL 1 through DL N). An access line 206 may also be referred to as a “row line” or a “word line,” and a digit line 208 may also be referred to a “column line” or a “bit line.” Activating or selecting an access line 206 or a digit line 208 may include applying a voltage to the respective line. An access line 206 and/or a digit line 208 may comprise, consist of, or consist essentially of a conductive material, such as a metal (e.g., copper, aluminum, gold, titanium, or tungsten) and/or a metal alloy, among other examples. In FIG. 2, each row of memory cells 204 is connected to a single access line 206, and each column of memory cells 204 is connected to a single digit line 208. By activating one access line 206 and one digit line 208 (e.g., applying a voltage to the access line 206 and digit line 208), a single memory cell 204 may be accessed at (e.g., is accessible via) the intersection of the access line 206 and the digit line 208. The intersection of the access line 206 and the digit line 208 may be called an “address” of a memory cell 204.

In some implementations, the logic storing device of a memory cell 204, such as a capacitor, may be electrically isolated from a corresponding digit line 208 by a selection component, such as a transistor. The access line 206 may be connected to and may control the selection component. For example, the selection component may be a transistor, and the access line 206 may be connected to the gate of the transistor. Activating the access line 206 results in an electrical connection or closed circuit between the capacitor of a memory cell 204 and a corresponding digit line 208. The digit line 208 may then be accessed (e.g., is accessible) to either read from or write to the memory cell 204.

A row decoder 210 and a column decoder 212 may control access to memory cells 204. For example, the row decoder 210 may receive a row address from a memory controller 214 and may activate the appropriate access line 206 based on the received row address. Similarly, the column decoder 212 may receive a column address from the memory controller 214 and may activate the appropriate digit line 208 based on the column address.

Upon accessing a memory cell 204, the memory cell 204 may be read (e.g., sensed) by a sense component 216 to determine the stored data state of the memory cell 204. For example, after accessing the memory cell 204, the capacitor of the memory cell 204 may discharge onto its corresponding digit line 208. Discharging the capacitor may be based on biasing, or applying a voltage, to the capacitor. The discharging may induce a change in the voltage of the digit line 208, which the sense component 216 may compare to a reference voltage (not shown) to determine the stored data state of the memory cell 204. For example, if the digit line 208 has a higher voltage than the reference voltage, then the sense component 216 may determine that the stored data state of the memory cell 204 corresponds to a first value, such as a binary 1. Conversely, if the digit line 208 has a lower voltage than the reference voltage, then the sense component 216 may determine that the stored data state of the memory cell 204 corresponds to a second value, such as a binary 0. The detected data state of the memory cell 204 may then be output (e.g., via the column decoder 212) to an output component 218 (e.g., a data buffer). A memory cell 204 may be written (e.g., set) by activating the appropriate access line 206 and digit line 208. The column decoder 212 may receive data, such as input from input component 220, to be written to one or more memory cells 204. A memory cell 204 may be written by applying a voltage across the capacitor of the memory cell 204.

The memory controller 214 may control the operation (e.g., read, write, re-write, refresh, and/or recovery) of the memory cells 204 via the row decoder 210, the column decoder 212, and/or the sense component 216. The memory controller 214 may generate row address signals and column address signals to activate the desired access line 206 and digit line 208. The memory controller 214 may also generate and control various voltages used during the operation of the memory array 202.

As indicated above, FIG. 2 is provided as an example. Other examples may differ from what is described with respect to FIG. 2.

High bandwidth memory is a type of high-performance DRAM designed to provide higher bandwidth as compared to DDR memory. High bandwidth memory may employ stacking multiple memory chips vertically and connecting the multiple memory chips using an interconnect, such as through-silicon vias (TSVs). High bandwidth memory may provide greater memory bandwidth than DDR memory due to its wide memory interface and stacked architecture. High bandwidth memory may provide lower power consumption than DDR memory due to its lower operating voltage and shorter signal paths. High bandwidth memory may utilize vertically stacked DRAM dies connected with TSVs, which may reduce the need for a large memory bus. High bandwidth memory may reduce space on a printed circuit board (PCB) since the high bandwidth memory is directly integrated with the processor. High bandwidth memory may be used in high-performance applications. For example, high bandwidth memory may be used in graphical processing units (GPUs), artificial intelligence (AI) accelerators, field-programmable gate arrays (FPGAs), or high-performance computing (HPC) workloads.

High bandwidth memory (HBM) (first generation) may support approximately 1 gigabits per second (Gbps) per pin and approximately 128 gigabytes per second (GB/s) bandwidth per stack. HBM2 may support approximately 2 Gbps per pin and up to approximately 256 GB/s bandwidth per stack. HBM3 may support approximately 6.4 Gbps per pin and approximately 820 GB/s bandwidth per stack. HBM4 may support approximately 1 terabyte per second (TB/s) bandwidth per stack.

High bandwidth memory may stack multiple DRAM dies vertically on top of each other, unlike DDR memory in which memory chips are laid out horizontally. Such stacking may increase memory density while reducing a physical footprint. Each stack may include multiple DRAM dies (e.g., 4, 8, or 12 dies per stack) and a base logic die at the bottom, which may manage communication between the stacked memory and the processor. High bandwidth memory may use TSVs to connect the vertically stacked DRAM layers. The TSVs may be vertical connections etched through silicon wafers, which may allow signals to pass directly between layers instead of routing the signals around a stack, which may reduce latency and power consumption. The TSVs may provide numerous high-speed interconnects between different layers. Micro bumps may be solder connections between stacked dies that maintain signal integrity. High bandwidth memory may achieve the high bandwidth by using a relatively wide memory interface as compared to DDR memory. For example, each stack may be 1024 bits wide, and multiple stacks may be combined for even greater bandwidth. The relatively wide memory interface may allow high bandwidth memory to transfer more data per clock (CLK) cycle at lower speeds, which may improve efficiency. High bandwidth memory may be placed close to the processor using a silicon interposer, which is a layer that connects the processor to the high bandwidth memory with high-speed traces. Shorter distances between the high bandwidth memory and the processor may reduce data travel time, which may improve latency and power efficiency. High bandwidth memory may be integrated with the processor, unlike off-chip memory, which may enable faster data transfer.

In high bandwidth memory, a parity self-test may be a diagnostic check performed to verify data integrity using parity bits. The parity self-test may be performed to ensure that no data corruption occurs during storage or transmission. The parity self-test may occur periodically or may be triggered manually (e.g., during bootup or system diagnostics).

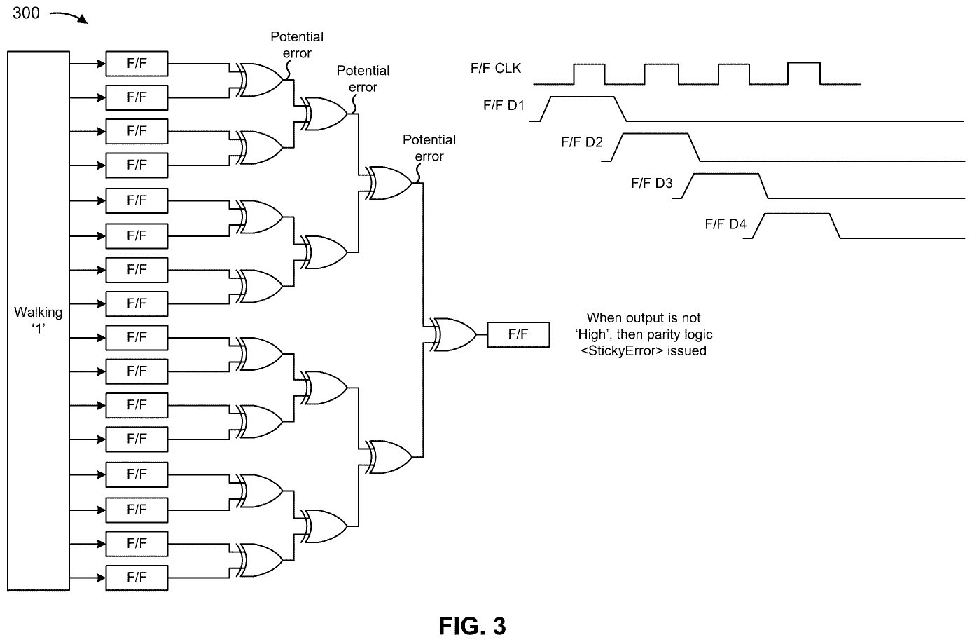

FIG. 3 is a diagram of an example 300 of a parity self-test. The operations described in connection with FIG. 3 may be performed by the memory system 110 and/or one or more components of the memory system 110, such as the memory system controller 115, one or more memory devices 120, and/or one or more local controllers 125.

As shown in FIG. 3, in a parity self-test, data may be latched in a plurality of flip-flops (F/F). A flip-flop may be a circuit that stores one bit of data. The data may include multiple “0” values and one “1” value. For example, the plurality of flip-flops may include 16 flip-flops. At a first time, an input of 1 may be provided to a first flip-flop, and an input of 0 may be provided to remaining flip-flops. At a second time, an input of 1 may be provided to a second flip-flop, and an input of 0 may be provided to remaining flip-flops. This process may be repeated 16 times corresponding to the 16 flip-flops. This process may be referred to as “walking 1” because an input of 1 may be provided to different flip-flops each time. The data may be subjected to a plurality of XOR operations. A check may be performed as to whether an even number of 1s or an odd number of 1s result from the plurality of XOR operations. Since only one flip-flop may receive an input of 1 (high) and remaining flip-flops may receive an input of 0 (low), an output of “high” may indicate no error. On the other hand, when an output is not “high”, an error (e.g., sticky error) may be issued in parity logic. In other words, when the output is not “high”, the plurality of XOR operations may result in the error. The error may be associated with an issue in the parity logic. The error may be associated with a signal that is referred to as “sticky error”.

As further shown in FIG. 3, in a timing diagram, a signal associated with a flip-flop CLK may be determined over a period of time. The signal may be a CLK signal. Signals associated with a first flip-flop, a second flip-flop, a third flip-flop, a fourth flip-flop, and so on may be determined over the period of time. For a given flip-flop, a signal may be high when that flip-flop is being tested, and the signal may be low when that flip-flop is not being tested.

For high bandwidth memory, the parity self-test may be supported to check the plurality of XOR operations. The parity self-test may be a write and read parity test. However, the parity self-test may not indicate which specific XOR operation is associated with an error (failure). For example, an input that is directed to a flip-flop may be associated with multiple XOR operations as part of the parity self-test. The parity self-test may indicate whether or not an error occurred during at least one XOR operation of the plurality of XOR operations, but the parity self-test may not indicate which specific XOR operation (or which specific multiple XOR operations) is associated with the error. Each XOR operation may potentially be associated with an error, which may result in the output not being “high”. An inability to determine which XOR operation is associated with an error may degrade an effectiveness of the parity self-test, thereby degrading an overall system performance.

As indicated above, FIG. 3 is provided as an example. Other examples may differ from what is described with regard to FIG. 3.

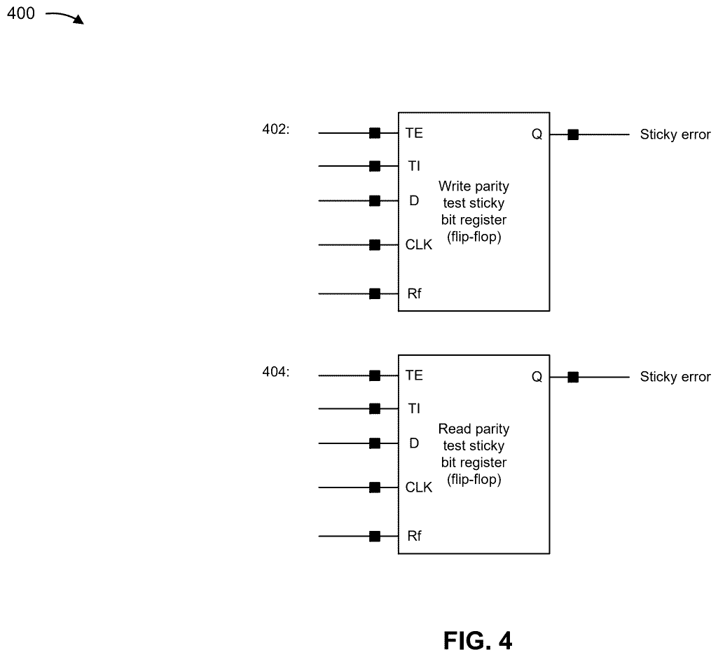

FIG. 4 is a diagram of an example 400 of a parity test sequence. The operations described in connection with FIG. 4 may be performed by the memory system 110 and/or one or more components of the memory system 110, such as the memory system controller 115, one or more memory devices 120, and/or one or more local controllers 125.

A parity test sequence may be employed to check whether an error or defect is present in parity logic. As part of the parity test sequence, a write parity test mode may be enabled, a write command may be performed n times, and then the write parity test mode may be disabled, where n is a positive integer. As part of the parity test sequence, a read parity test mode may be enabled, a read command may be performed m times, and then the read parity test mode may be disabled, where m is a positive integer. A sticky error bit may be read after the parity test sequence is finished. The sticky error bit may refer to an error flag or status bit that remains set (or “sticky”) after the error is detected until cleared. However, an exact location of the error may be unknown when testing the parity logic.

As shown by reference number 402, a write parity test sticky bit register (or flip-flop) may include a test enable (TE) pin, a test input (TI) pin, a data input (D) pin, a CLK pin, a register file (Rf) pin, and an output (Q) pin. The write parity test sticky bit register may be associated with a sticky error. The write parity test sticky bit register may be associated with a write parity test. The write parity test sticky bit register may be associated with a last flip-flop shown in FIG. 3. As shown by reference number 404, a read parity test sticky bit register (or flip-flop) may include a TE pin, a TI pin, a D pin, a CLK pin, an Rf pin, and a Q pin. The read parity test sticky bit register may be associated with a sticky error. The read parity test sticky bit register may be associated with a read parity test. The read parity test sticky bit register may be associated with a last flip-flop shown in FIG. 3.

As indicated above, FIG. 4 is provided as an example. Other examples may differ from what is described with regard to FIG. 4.

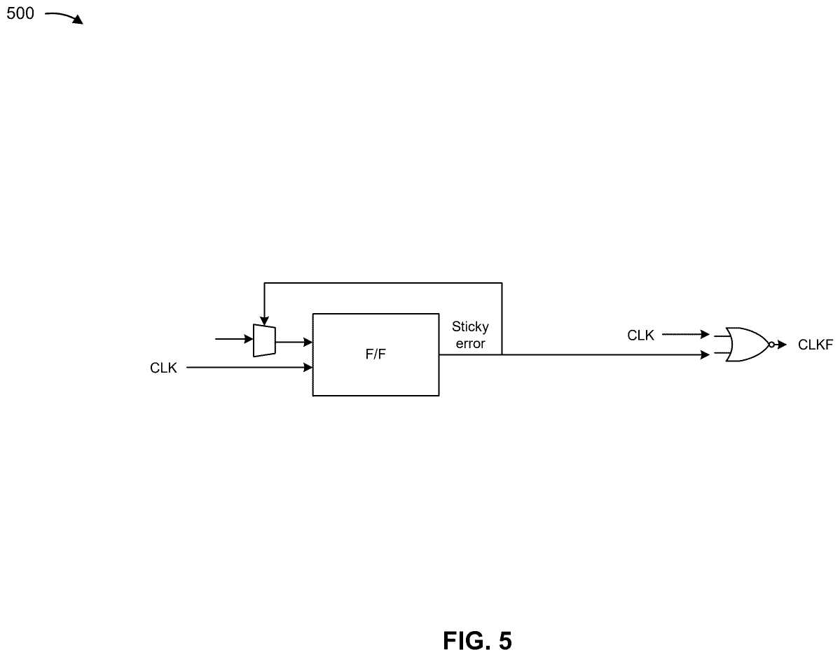

FIG. 5 is a diagram of an example 500 of an error signal. The operations described in connection with FIG. 5 may be performed by the memory system 110 and/or one or more components of the memory system 110, such as the memory system controller 115, one or more memory devices 120, and/or one or more local controllers 125.

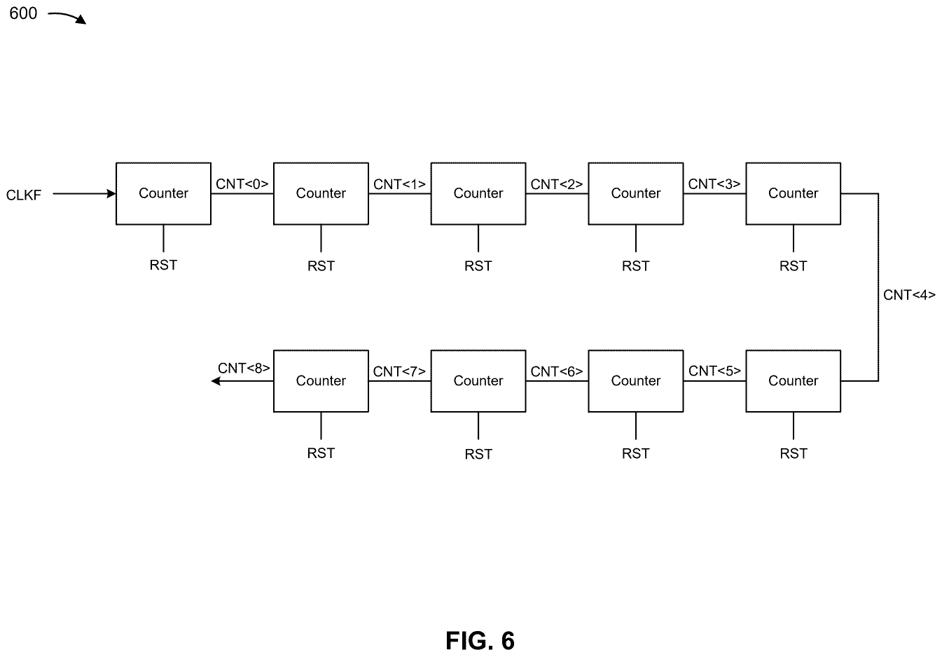

As shown in FIG. 5, a flip-flop (e.g., the last flip-flop shown in FIG. 3) may issue a sticky error signal, which may be based at least in part on an issue in parity logic. The sticky error signal may be associated with a sticky error bit. The sticky error signal may be high when an output of the parity logic is not “high”. The sticky error signal may be high to indicate that there is an error associated with the parity logic. The sticky error signal may be low when the output of the parity logic is “high”. The sticky error signal may be low to indicate that there is no error associated with the parity logic. The sticky error signal may be an output of the flip-flop, where the output may be based at least in part on a plurality of inputs. The inputs may include respective signals to a TE pin, a TI pin, a D pin, a CLK pin, and/or an Rf pin associated with the flip-flop. The CLK pin may be associated with a first CLK signal. The sticky error signal may be provided to a logic gate, which may produce a complementary CLK signal (CLKF). The complementary CLK signal may be based at least in part on the sticky error signal and a second CLK signal. The complementary CLK signal may be an input to a plurality of counters (e.g., as shown in FIG. 6).

As indicated above, FIG. 5 is provided as an example. Other examples may differ from what is described with regard to FIG. 5.

FIG. 6 is a diagram of an example 600 of a parity test counter. The operations described in connection with FIG. 6 may be performed by the memory system 110 and/or one or more components of the memory system 110, such as the memory system controller 115, one or more memory devices 120, and/or one or more local controllers 125.

As shown in FIG. 6, a complementary CLK signal may be an input to a plurality of counters. The complementary CLK signal may be based at least in part on a CLK signal and a sticky error signal (e.g., as shown in FIG. 5). The sticky error signal may be high to indicate an error in a parity logic, or the sticky error signal may be low to indicate no error in the parity logic. A counter in the plurality of counters may be associated with a reset (RST) pin. The counter may produce an output (e.g., cnt<0> for a first counter, cnt<1> for a second counter, and so on). The counter may be a hardware counter (e.g., a register to track hardware activity). The counter may be a block that has a clock signal as an input. When an input clock toggles, the counter may increase counter (CNT) bits. For example, the CNT bits may initially point to “0”, and after a first toggle, the CNT bits may point to “1”. In one example, the counter may register a number of write command and/or a number of read commands which are issued by the memory system 110.

In some implementations, a quantity associated with the plurality of counters, or a counter size, may depend on a number of commands (e.g., amount of data) associated with the parity logic. For example, for 1024 read/write commands, 10 separate counters may be needed. In the example shown in FIG. 6, 9 separate counters may be used. The plurality of counters may be shared for both a write operation and a read operation. The quantity associated with the plurality of counters may depend on m and n values, where the m and n values may be associated with a write parity test mode and a read parity test mode, respectively. A number of counters may be equal to a number of flip-flops associated with a “walking 1” operation. In order to determine which flip-flop or logic that is related to a flip-flop has an issue, an equivalent number of flip-flops and counters may be employed. In one example, an 8 bits counter may be employed, which may be based on a number of data lines.

In some implementations, when the sticky error signal is low (e.g., no error in the parity logic), a counter increase may be permitted. For example, when the sticky error is low, a CLK signal may total a counter when checking an XOR logic associated with the parity logic. When the sticky error is high (e.g., an error in the parity logic is present), the counter increase may be blocked. The counter increase may be blocked when the error occurs. When the error occurs, the counter may stop, which may indicate that the flip-flop that counter points to or a downstream logic that is associated to that flip-flop may have the error. A specific flip-flop that is associated with the error may be identified, and the CNT bits may provide information regarding the flip-flop having the error. The complementary CLK signal and/or the CLK signal may be blocked and the counter may be stopped. Depending on which counter in the plurality of counters stops the counter increase, an exact flip-flop and/or XOR logic associated with the exact flip-flip may be identified as a source of the error in the parity logic. A “walking 1” pattern may associate one flip-flop to latch “1”. When the counter is stopped at a first command, a first flip-flop or one of the first XOR logics in each stage may be associated with the error. For example, when a counter increase associated with a first counter in the plurality of counters is blocked, a specific flip-flop and/or XOR logic associated with the first counter may be identified as the source of the error. As another example, when a counter increase associated with a last counter in the plurality of counters is blocked, a specific flip-flop and/or XOR logic associated with the last counter may be identified as the source of the error. A given flip-flop may be associated with multiple XOR logic gates. When the counter is stopped, the given flip-flop may be identified as the flip-flop having the error, and one or more XOR logic gates of the multiple XOR logic gates may be a root cause of the error. In some implementations, once the error occurs in the parity logic, the sticky error signal may block a clock toggle (e.g., the complementary CLK signal and/or the CLK signal may be blocked, such that the sticky error signal may block the counter increase and the counter may be stopped). The counter may stop at a last healthy flip-flip or XOR logic (e.g., a last flip-flop or XOR logic having no error), which may help to identify the source/location of the error in the parity logic.

In some implementations, a test mode may verify one data line per read command or per write command. A test may be sequentially processed in the order of the data lines. Once an error does not occur, no error may be present on the data line. When an error occurs at a certain command, a failure data line may be defined. When the failure data line is defined, a counter increase may be stopped. After the test is completed, a number of counters may be read out, which may indicate which specific data line is associated with failure.

As indicated above, FIG. 6 is provided as an example. Other examples may differ from what is described with regard to FIG. 6.

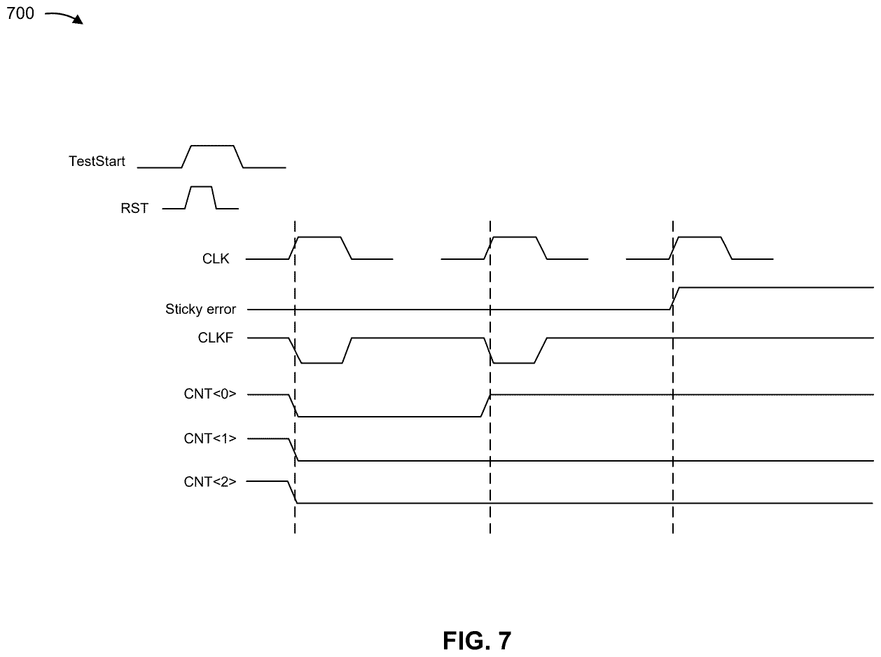

FIG. 7 is a diagram of an example 700 of a timing diagram associated with a parity test counter. The operations described in connection with FIG. 7 may be performed by the memory system 110 and/or one or more components of the memory system 110, such as the memory system controller 115, one or more memory devices 120, and/or one or more local controllers 125.

As shown in FIG. 7, a timing diagram associated with a parity test counter may be obtained. The timing diagram may indicate a timing for a CLK signal, a sticky error signal, a complementary CLK signal, and one or more counters associated with a plurality of counters. In this example, the one or more counters may be associated with a first counter (cnt<0>), a second counter (cnt<1>), and a third counter (cnt<2>). In this example, the sticky error signal may become high, which may indicate an error in parity logic. The sticky error signal may go from low to high, which may indicate the error in the parity logic. When the error is present, the complementary CLK signal may be blocked. A counter may stop based at least in part on the complementary CLK signal being blocked. In other words, the counter may stop when the complementary CLK signal is blocked, and a position at which the counter stops may indicate which specific flip-flop and/or XOR logic gate is associated with the error. As an example, when a counter associated with cnt<0> is stopped, a flip-flop associated with that counter may have the error. When a counter associated with cnt<2> is stopped, a flip-flop associated with that counter may have the error. In this example, timing diagrams for cnt<3>, cnt<4> and so on are not shown because the error has already been detected.

As indicated above, FIG. 7 is provided as an example. Other examples may differ from what is described with regard to FIG. 7.

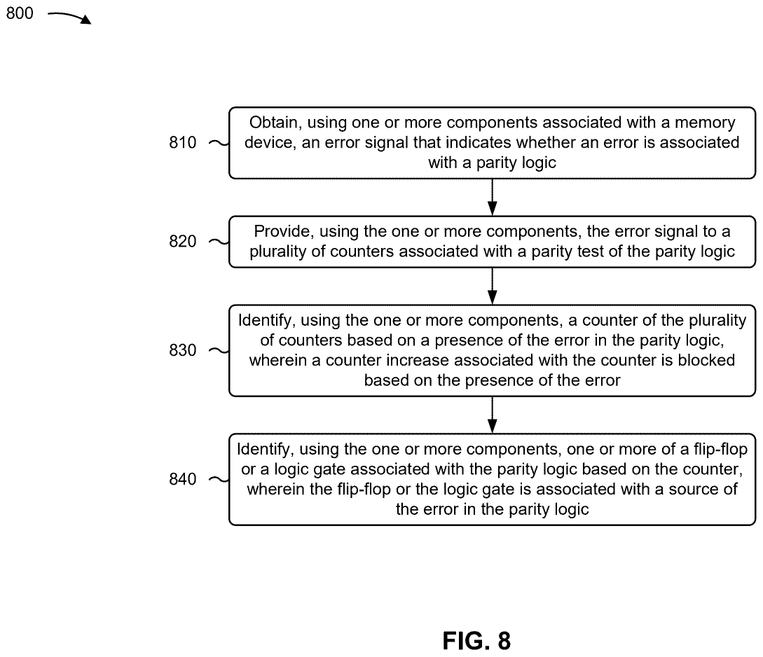

FIG. 8 is a flowchart of an example method 800 associated with counter-based parity testing. In some implementations, a memory device (e.g., the memory device 120) may perform or may be configured to perform the method 800. In some implementations, another device or a group of devices separate from or including the memory device (e.g., the system 100) may perform or may be configured to perform the method 800. Additionally, or alternatively, one or more components of the memory device may perform or may be configured to perform the method 800. Thus, means for performing the method 800 may include the memory device and/or one or more components of the memory device. Additionally, or alternatively, a non-transitory computer-readable medium may store one or more instructions that, when executed by the memory device, cause the memory device to perform the method 800.

As shown in FIG. 8, the method 800 may include obtaining, using one or more components associated with a memory device, an error signal that indicates whether an error is associated with a parity logic (block 810). As further shown in FIG. 8, the method 800 may include providing, using the one or more components, the error signal to a plurality of counters associated with a parity test of the parity logic (block 820). As further shown in FIG. 8, the method 800 may include identifying, using the one or more components, a counter of the plurality of counters based on a presence of the error in the parity logic, wherein a counter increase associated with the counter is blocked based on the presence of the error (block 830). As further shown in FIG. 8, the method 800 may include identifying, using the one or more components, one or more of a flip-flop or a logic gate associated with the parity logic based on the counter, wherein the flip-flop or the logic gate is associated with a source of the error in the parity logic (block 840).

The method 800 may include additional aspects, such as any single aspect or any combination of aspects described below and/or described in connection with one or more other methods or operations described elsewhere herein.

In a first aspect, the error signal is associated with a high value based on the presence of the error, or the error signal is associated with a low value based on an absence of the error.

In a second aspect, alone or in combination with the first aspect, a quantity associated with the plurality of counters is based on a quantity of read or write commands associated with the parity logic.

In a third aspect, alone or in combination with one or more of the first and second aspects, the method 800 includes providing a complementary clock signal to the plurality of counters, wherein the complementary clock signal is based on the error signal.

In a fourth aspect, alone or in combination with one or more of the first through third aspects, the error signal blocks a clock toggle based on the presence of the error, and the counter is stopped at a last error-free flip-flop or a last error-free logic gate prior to the clock toggle being blocked.

In a fifth aspect, alone or in combination with one or more of the first through fourth aspects, different counters in the plurality of counters are associated with different flip-flops of the parity logic, and a flip-flop is associated with one or more logic gates.

In a sixth aspect, alone or in combination with one or more of the first through fifth aspects, the logic gate is an XOR logic gate.

In a seventh aspect, alone or in combination with one or more of the first through sixth aspects, the memory device is associated with high bandwidth memory.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

In some implementations, a memory device includes one or more components configured to: obtain an error signal that indicates whether an error is associated with a parity logic; provide the error signal to a plurality of counters associated with a parity test of the parity logic; identify a counter of the plurality of counters based on a presence of the error in the parity logic, wherein a counter increase associated with the counter is blocked based on the presence of the error; and identify one or more of a flip-flop or a logic gate associated with the parity logic based on the counter, wherein the flip-flop or the logic gate is associated with a source of the error.

In some implementations, a method includes obtaining, using one or more components associated with a memory device, an error signal that indicates whether an error is associated with a parity logic; providing, using the one or more components, the error signal to a plurality of counters associated with a parity test of the parity logic; identifying, using the one or more components, a counter of the plurality of counters based on a presence of the error in the parity logic, wherein a counter increase associated with the counter is blocked based on the presence of the error; and identifying, using the one or more components, one or more of a flip-flop or a logic gate associated with the parity logic based on the counter, wherein the flip-flop or the logic gate is associated with a source of the error in the parity logic.

In some implementations, an apparatus includes means for obtaining an error signal that indicates whether an error is associated with a parity logic; means for providing the error signal to a plurality of counters associated with a parity test of the parity logic; means for identifying a counter of the plurality of counters based on a presence of the error in the parity logic, wherein a counter increase associated with the counter is blocked based on the presence of the error; and means for identifying one or more of a flip-flop or a logic gate associated with the parity logic based on the counter, wherein the flip-flop or the logic gate is associated with a source of the error in the parity logic.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
obtain an error signal that indicates whether an error is associated with a parity logic;
provide the error signal to a plurality of counters associated with a parity test of the parity logic;
identify a counter of the plurality of counters based on a presence of the error in the parity logic, wherein a counter increase associated with the counter is blocked based on the presence of the error; and
identify one or more of a flip-flop or a logic gate associated with the parity logic based on the counter, wherein the flip-flop or the logic gate is associated with a source of the error.

2. The memory device of claim 1, wherein the error signal is associated with a high value based on the presence of the error.

3. The memory device of claim 1, wherein the error signal is associated with a low value based on an absence of the error.

4. The memory device of claim 1, wherein a quantity associated with the plurality of counters is based on a quantity of read or write commands associated with the parity logic.

5. The memory device of claim 1, wherein the one or more components are further configured to:
provide a complementary clock signal to the plurality of counters, wherein the complementary clock signal is based on the error signal.

6. The memory device of claim 1, wherein the error signal blocks a clock toggle based on the presence of the error, and wherein the counter is stopped at a last error-free flip-flop or a last error-free logic gate prior to the clock toggle being blocked.

7. The memory device of claim 1, wherein different counters in the plurality of counters are associated with different flip-flops of the parity logic, and wherein a flip-flop is associated with one or more logic gates.

8. The memory device of claim 1, wherein the logic gate is an XOR logic gate.

9. The memory device of claim 1, wherein the memory device is associated with high bandwidth memory.

10. A method, comprising:
obtaining, using one or more components associated with a memory device, an error signal that indicates whether an error is associated with a parity logic;
providing, using the one or more components, the error signal to a plurality of counters associated with a parity test of the parity logic;
identifying, using the one or more components, a counter of the plurality of counters based on a presence of the error in the parity logic, wherein a counter increase associated with the counter is blocked based on the presence of the error; and
identifying, using the one or more components, one or more of a flip-flop or a logic gate associated with the parity logic based on the counter, wherein the flip-flop or the logic gate is associated with a source of the error.

11. The method of claim 10, wherein the error signal is associated with a high value based on the presence of the error, or the error signal is associated with a low value based on an absence of the error.

12. The method of claim 10, wherein a quantity associated with the plurality of counters is based on a quantity of read or write commands associated with the parity logic.

13. The method of claim 10, further comprising:
providing a complementary clock signal to the plurality of counters, wherein the complementary clock signal is based on the error signal.

14. The method of claim 10, wherein the error signal blocks a clock toggle based on the presence of the error, and wherein the counter is stopped at a last error-free flip-flop or a last error-free logic gate prior to the clock toggle being blocked.

15. The method of claim 10, wherein different counters in the plurality of counters are associated with different flip-flops of the parity logic, and wherein a flip-flop is associated with one or more logic gates.

16. The method of claim 10, wherein the logic gate is an XOR logic gate.

17. The method of claim 10, wherein the memory device is associated with high bandwidth memory.

18. An apparatus, comprising:
means for obtaining an error signal that indicates whether an error is associated with a parity logic;
means for providing the error signal to a plurality of counters associated with a parity test of the parity logic;
means for identifying a counter of the plurality of counters based on a presence of the error in the parity logic, wherein a counter increase associated with the counter is blocked based on the presence of the error; and
means for identifying one or more of a flip-flop or a logic gate associated with the parity logic based on the counter, wherein the flip-flop or the logic gate is associated with a source of the error.

19. The apparatus of claim 18, wherein the error signal is associated with a high value based on the presence of the error, or the error signal is associated with a low value based on an absence of the error.

20. The apparatus of claim 18, wherein a quantity associated with the plurality of counters is based on a quantity of read or write commands associated with the parity logic.

21. The apparatus of claim 18, further comprising:
means for providing a complementary clock signal to the plurality of counters, wherein the complementary clock signal is based on the error signal.

22. The apparatus of claim 18, wherein the error signal blocks a clock toggle based on the presence of the error, and wherein the counter is stopped at a last error-free flip-flop or a last error-free logic gate prior to the clock toggle being blocked.

23. The apparatus of claim 18, wherein different counters in the plurality of counters are associated with different flip-flops of the parity logic, and wherein a flip-flop is associated with one or more logic gates.

24. The apparatus of claim 18, wherein the logic gate is an XOR logic gate.

25. The apparatus of claim 18, wherein the apparatus is associated with high bandwidth memory.
